(19) United States
(12) Patent Application Publication
(10) Pub. No.: US 2008/0221254 A1
(43) Pub. Date: Sep. 11, 2008

(54) MATERIAL FOR MAKING LONG FIBER FILLED THERMOPLASTICS WITH IMPROVED ADDITIVE EVENNESS AND PHYSICAL PROPERTIES

(76) Inventors: Mohamed Hassan El-Zayatie, Drexel Hill, PA (US); Kurtis J. Klein, Columbus, IN (US); Shrish Rane, Batesville, IN (US)

Correspondence Address: SABIC - LNP-CE 08CE;SABIC Innovative Plastics - IP LEGAL, ONE PLASTICS AVENUE, PITTSFIELD, MA, 01201-3697, US

(21) Appl. No.: 11/870,689

(22) Filed: Oct. 11, 2007

Related U.S. Application Data
(60) Provisional application No. 60/829,592, filed on Oct. 16, 2006.
(60) Provisional application No. 60/938,487, filed on May 17, 2007.

(51) Int. Cl. C08K 3/40; C08L 81/00; C08L 67/00; C08L 77/00; C08L 79/02; C08K 3/04; C08L 79/08; C08L 83/08; C08L 27/06

(52) U.S. Cl. 524/494; 524/543; 524/612; 524/609; 524/599; 524/592; 524/588; 524/495

(57) ABSTRACT

A material and method for making long fiber filled thermoplastics with improved additive evenness and physical properties that includes a fiber-filled thermoplastic resin and a coating layer that contains the one or more additives to eventually be dispersed in the molded article. The coating layer is added in a manner such that the coating does not substantially intermix with the thermoplastic resin to form the long fiber-filled thermoplastic material. The long fiber-filled thermoplastic material may then formed into a molded article using the long glass fiber-filled thermoplastic material. Since the long fiber-filled thermoplastic material is not formed into pellets prior to formation into the article, the problems associated with prior art methods regarding dispersion of the additives are avoided and the resulting molded article has improved additive evenness and characteristics as compared to prior art molded articles formed from a dry blend of pellets.

### CROSS REFERENCE TO RELATED APPLICATIONS

This application claims priority to U.S. Provisional Application Ser. No. 60/829592 filed on Oct. 16, 2006 and U.S. Provisional Application Ser. No. 60/938487 filed on May 17, 2007, which are incorporated herein by reference in their entirety.

### FIELD OF INVENTION

The present invention relates to thermoplastic composites and, in particular, long fiber thermoplastic composites having improved additive evenness and improved physical properties.

### BACKGROUND OF INVENTION

Fiber-reinforced thermoplastic polymer structural components are most commonly manufactured from long fiber thermoplastic (LFT) granulates (pellets), glass mat thermoplastic (GMT) sheets, or pultruded sections. Long fiber-reinforced granulates often include glass fiber bundles encapsulated with a thermoplastic through a cable coating or a pultrusion process.

However, one of the issues associated with long fiber-reinforced pellets is the uneven distribution of additives used in the molding process. This uneven distribution of additives in molded plastic articles made from dry blending has been discussed and recognized as a problem. The prior art has attempted to overcome this problem using various solutions. For example, in one proposed solution, the unevenness of some additives was addressed through the application of more shear forces during the molding process. However, the application of more shear force results in greater breakage of the long fibers during the molding process that adversely affects the fiber length and, therefore, physical properties of the molded articles.

Another prior art solution is the co-extrusion of the additives during the extrusion process. Co-extrusion of additives has been a good solution for non-fiber containing pellets. However, this solution is difficult to use with long fiber containing products because, during the production of long fiber pellets, there are generally processing limitations that reduce the raw material options that can be added.

Alternatively, another prior art approach for adding additives to non-fiber thermoplastics has been through the use of coating techniques. These techniques have been used, for example, to include one or more additives for imparting a variety of properties such as mold release, antistatic, color, lubrication, adhesion prevention, improved flowing, segregation prevention, flame resistance, ultraviolet light prevention, segregation prevention and to incorporate blowing agents onto pellets used for molding articles or making plastics tiles.

These prior art techniques used for coating thermoplastics pellets with the corresponding additive include A) encapsulating the pre-cut pellets by using liquid or a paste carrying the additive; B) spray coating the pellets with the additive; and C) over-coating the thermoplastics strand with another layer of resin carrying the additive, followed by solidification of the melt then pelletizing. However, these coating techniques have not been applied to long fiber materials due to the difficulties associated with getting dispersion of the additive into a molded article due to the presence of the long fiber interfering with the dispersion of the additive once the coated thermoplastic has been pelletized and then attempted to be formed into a molded article.

Accordingly, it would be beneficial to provide a system and method for dispersing additives into a long fiber plastic molded article without adversely affecting the physical properties of the article. It would also be beneficial to provide a molded plastic article having long fibers and additives that are substantially dispersed. It would also be beneficial to provide molded plastic article having long fibers and having therein a dispersed additive to give the molded article substantial evenness in terms of the characteristic of the selected additive. It would also be beneficial to provide molded plastic article having long fibers and additives that are substantially dispersed to provide improved physical properties.

### SUMMARY OF THE INVENTION

The present invention provides a system and method for making long fiber-filled thermoplastic materials having improved dispersion of additives. These additives may include color additives, flame retardant additives, weatherability additives and/or other additives that permit improved additive evenness and/or physical properties of a molded article as compared to prior art methods. The present invention initially forms a fiber-filled thermoplastic resin and then adds a subsequent coating layer that contains the one or more additives to eventually be dispersed in the molded article. The coating layer is added in a manner such that the coating does not substantially intermix with the thermoplastic resin to form the long fiber-filled thermoplastic material. The long fiber-filled thermoplastic material is then sent to a molding machine, such as an extruder, wherein a molded article is formed from the long glass fiber-filled thermoplastic material. Since the long fiber-filled thermoplastic material is not formed into pellets prior to formation into the article, the problems associated with prior art methods regarding dispersion of the additives are avoided and the resulting molded article has much better dispersion of additives therein. And, in those embodiments wherein the additive is a color, the resulting molded article has much improved color evenness as compared to prior art molded articles formed from a dry blend of pellets. In those embodiments wherein the additive is a flame retardant, the resulting molded article has much improved distribution of the flame retardant as compared to prior art molded articles formed from a dry blend of pellets. In those embodiments wherein the additive is a weatherability additive, the resulting molded article has much improved distribution of the additive and therefore weathers more evenly as compared to prior art molded articles formed from a dry blend of pellets.

Accordingly, in one aspect, the present invention provides a material for making long glass fiber filled thermoplastics with improved additive evenness and physical properties that includes a first thermoplastic resin material containing a plurality of reinforcing fiber strands and a second thermoplastic resin material containing at least one additive coated on the first thermoplastic resin material.

In another aspect, the present invention provides a method of making long fiber filled thermoplastics with improved additive evenness and physical properties including the steps of pultruding a first thermoplastic resin material having a plurality of reinforcing fiber strands contained therein and extruding a second thermoplastic resin material containing at least one additive onto the first thermoplastic resin material to form a coating on at least a portion of the first thermoplastic resin material.

### BRIEF DESCRIPTION OF THE DRAWINGS

FIGS. 1 and 2 show the Accelerated Xenon Arc weathering results for two embodiments of the present invention in black and gray colors as compared against existing un-reinforced ASA formulations in the same colors.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the term “comprising” may include the embodiments “consisting of” and “consisting essentially of.” All ranges disclosed herein are inclusive of the endpoints and are independently combinable. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

The present invention provides a system and method for making long fiber filled thermoplastic materials that may then be used to form molded articles. The system and method enable better dispersion of additives that are included in the molding process. These additives may include color additives, flame retardant additives, weatherability additives, or a combination thereof such that the improved dispersion results in better physical properties and/or additive characteristics of the molded article. By improving the dispersion of the additives without the use of excess shear forces conventionally used in prior art solutions, the long fibers in the molded article have reduced breakage, thereby enabling the molded article to have better physical properties as compared to molded articles formed using prior art methods.

Accordingly, in one aspect, the present invention provides a system and method for making long fiber-filled thermoplastic materials. These long fiber-filled thermoplastic materials include a base thermoplastic resin, a plurality of long glass fibers within the resin, and at least one additive that is to be dispersed within a molded article formed using the long glass fiber-filled thermoplastic materials. The at least one additive is added to the long fiber filled thermoplastic materials in a manner to enable better dispersion of the at least one additive without the use of excessive shear forces that could damage the long fibers and, as a result, the physical properties of the resulting molded article.

In the present invention, a coating process is used to improve evenness of additive dispersion when distributing different additives throughout articles molded from long fiber containing pellets without having to excessively shear the melt during molding and sacrificing the physical properties of the molded articles or having to incorporate any unwanted residues in the final part.

Accordingly, in a first aspect, the long fiber-filled thermoplastic materials of the present invention include a thermoplastic resin. The thermoplastic resin used in the present invention may be selected from a wide variety of thermoplastic resins or blends of thermoplastic resins. The thermoplastic resin may also be a blend of polymers, copolymers, terpolymers, or combinations including at least one of the foregoing thermoplastic resins. Examples thermoplastic resins that may be used in the present invention include, but are not limited to, polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or the like, or a combination including at least one of the foregoing thermoplastic resins.

Specific non-limiting examples of blends of thermoplastic resins include acrylonitrile-butadiene-styrene/nylon, polycarbonate/acrylonitrile-butadiene-styrene, polyphenylene ether/polystyrene, polyphenylene ether/polyamide, polycarbonate/polyester, polyphenylene ether/polyolefin, acrylic-styrene-acrylonitrile (ASA), polycarbonate/ polyetherimides, and combinations including at least one of the foregoing blends of thermoplastic resins.

In one embodiment, the thermoplastic resin is a cycloaliphatic polyester. Cycloaliphatic polyesters are generally prepared by reaction of organic polymer precursors such as a diol with a dibasic acid or derivative. The diols useful in the preparation of the cycloaliphatic polyester polymers are straight chain, branched, or cycloaliphatic, preferably straight chain or branched alkane diols, and may contain from 2 to 12 carbon atoms. In another embodiment, the thermoplastic resin is an aliphatic polyamide.

Suitable examples of diols include ethylene glycol, propylene glycol, i.e., 1,2- and 1,3-propylene glycol; butane diol, i.e., 1,3- and 1,4-butane diol; diethylene glycol, 2,2-dimethyl-1,3-propane diol, 2-ethyl, 2-methyl, 1,3-propane diol, 1,3- and 1,5-pentane diol, dipropylene glycol, 2-methyl-1,5-pentane diol, 1,6-hexane diol, 1,4-cyclohexane dimethanol and particularly its cis- and trans-isomers, triethylene glycol, 1,10-decane diol, and mixtures of any of the foregoing. Particularly preferred is dimethanol bicyclo octane, dimethanol decalin, a cycloaliphatic diol or chemical equivalents thereof and particularly 1,4-cyclohexane dimethanol or its chemical equivalents. If 1,4-cyclohexane dimethanol is to be used as the diol component, it is generally preferred to use a mixture of cis- to trans-isomers in mole ratios of about 1:4 to about 4:1. Within this range, it is generally desired to use a mole ratio of cis- to trans-isomers of about 1:3.

The diacids useful in the preparation of the cycloaliphatic polyester polymers are aliphatic diacids that include carboxylic acids having two carboxyl groups each of which are attached to a saturated carbon in a saturated ring. Suitable examples of cycloaliphatic acids include decahydro naphthalene dicarboxylic acid, norbornene dicarboxylic acids, bicyclo octane dicarboxylic acids. Preferred cycloaliphatic diacids are 1,4-cyclohexanedicarboxylic acid and trans-1,4-cyclohexanedicarboxylic acids. Linear aliphatic diacids are also useful when the polyester has at least one monomer containing a cycloaliphatic ring. Illustrative examples of linear aliphatic diacids are succinic acid, adipic acid, dimethyl succinic acid, and azelaic acid. Mixtures of diacid and diols may also be used to make the cycloaliphatic polyesters.

In addition to the thermoplastic resin, the long glass fiber-filled thermoplastic materials of the present invention include a plurality of long glass fibers. As used herein, “long glass fibers” are glass fibers that, in one embodiment, have an average length greater than 0.5 mm. In another embodiment, the glass fibers have an average length greater than 10 mm. In still another embodiment, the glass fibers have an average length greater than 15 mm. The long glass fibers are added to the thermoplastic resin to impart improved physical properties to any molded article constructed from the long glass fiber-filled thermoplastic materials, such as impact strength, tensile strength and modulus. Since the glass fibers help impart the improved physical properties due, in part, to the length of the fibers, the long glass fiber-filled thermoplastic materials of the present invention beneficially are processed in a manner that prevents substantial breakage of the fibers. Therefore, the system and method of the present invention offer the opportunity to disperse additives in a more efficient manner than prior art techniques. In addition, the present invention permits the use of heat and/or shear-sensitive additives that otherwise may have degraded using prior art techniques.

Also, it is to be understood that while many of the long fiber-filled thermoplastic materials described herein utilize long glass fibers, the concepts of the present invention can be extended to other long fiber-filled thermoplastic materials, depending on the selected characteristics of the long fiber-filled thermoplastic material and any article molded from the long fiber-filled thermoplastic material. For example, in an alternative embodiment, the long fiber-filled thermoplastic material includes long carbon fibers to impart improved conductivity to the long fiber-filled thermoplastic materials and any article made therefrom. In another embodiment, the long fiber-filled thermoplastic material may include aramid fibers.

In addition to the thermoplastic resin and the long glass fiber, the long glass fiber-filled thermoplastic materials of the present invention include one or more additives. The one or more additives are included in the long glass fiber-filled thermoplastic materials to impart one or more selected characteristics to the long glass fiber-filled thermoplastic materials and any molded article made therefrom. Examples of additives that may be included in the present invention include, but are not limited to, heat stabilizers, process stabilizers, antioxidants, flame retardants, light stabilizers, plasticizers, antistatic agents, conductive additives, mold releasing agents, UV absorbers, lubricants, pigments, dyes, colorants, flow promoters or a combination of one or more of the foregoing additives.

Suitable heat stabilizers include, for example, organo phosphites such as triphenyl phosphite, tris-(2,6-dimethylphenyl)phosphite, tris-(mixed mono-and di-nonylphenyl)phosphite or the like; phosphonates such as dimethylbenzene phosphonate or the like, phosphates such as trimethyl phosphate, or the like, or combinations including at least one of the foregoing heat stabilizers. Heat stabilizers are generally used in amounts of from 0.01 to 0.5 parts by weight based on 100 parts by weight of the total composition, excluding any additives.

Suitable antioxidants include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations including at least one of the foregoing antioxidants. Antioxidants are generally used in amounts of from 0.01 to 0.5 parts by weight, based on 100 parts by weight of the total composition, excluding any additives.

Suitable flame retardants include, for example, phosphorus containing flame retardants, for example an organic phosphates and/or an organic compound containing phosphorus-nitrogen bonds. Examples include, but are not limited to, aromatic phosphates of the formula (GO)₃P=O, wherein each G is independently an alkyl, cycloalkyl, aryl, alkaryl, or aralkyl group, provided that at least one G is an aromatic group. Two of the G groups may be joined together to provide a cyclic group, for example, diphenyl pentaerythritol diphosphate, which is described by Axelrod in U.S. Pat. No. 4,154,775. Other suitable aromatic phosphates may be, for example, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like. In alternative embodiments, di- or polyfunctional aromatic phosphorus-containing compounds may be used as the flame retardant.

In alternative embodiments, inorganic flame retardants may also be used, for example sulfonate salts such as potassium perfluorobutane sulfonate (Rimar salt) and potassium diphenylsulfone sulfonate; salts formed by reacting for example an alkali metal or alkaline earth metal (preferably lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, BaCO₃, and BaCO₃ or fluoro-anion complex such as Li₃AlF₆, BaSiF₆, KBF₄, K₃AlF₆, KAlF₄, K₂SiF₆, and/or Na₃AlF₆ or the like.

Flame retardants are generally used in amounts of from 3.0 to 20 parts by weight, based on 100 parts by weight of the total composition, excluding any additives.

Suitable light stabilizers include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone or the like or combinations including at least one of the foregoing light stabilizers. Light stabilizers are generally used in amounts of from 0.01 to 3.0 parts by weight, based on 100 parts by weight of the total composition, excluding any additives.

Suitable plasticizers include, for example, phthalic acid esters such as dioctyl-4,5-epoxy-hexahydrophthalate, tris-(octoxycarbonylethyl)isocyanurate, tristearin, epoxidized soybean oil or the like, or combinations including at least one of the foregoing plasticizers. Plasticizers are generally used in amounts of from 0.5 to 3.0 parts by weight, based on 100 parts by weight of the total composition, excluding any additives.

Suitable antistatic agents include, for example, glycerol monostearate, sodium stearyl sulfonate, sodium dodecylbenzenesulfonate or the like, or combinations of the foregoing antistatic agents. In one embodiment, carbon fibers, carbon nanofibers, carbon nanotubes, carbon black, or any combination of the foregoing may be used in a polymeric resin containing chemical antistatic agents to render the composition electrostatically dissipative. Antistatic agents are generally used in amounts of from 0.1 to 3.0 parts by weight based on 100 parts by weight the total composition, excluding any additives.

Suitable mold releasing agents include for example, stearyl stearate, pentaerythritol tetrastearate, beeswax, montan wax, paraffin wax, or the like, or combinations including at least one of the foregoing mold release agents. Mold releasing agents are generally used in amounts of from 0.1 to 1.0 parts by weight, based on 100 parts by weight of the total composition, excluding any additives.

Suitable UV absorbers include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenylacryloyl)oxy]methyl]propane (UVINUL™ 3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than 100 nanometers; or the like, or combinations including at least one of the foregoing UV absorbers. UV absorbers are generally used in amounts of from 0.01 to 3.0 parts by weight, based on 100 parts by weight based on 100 parts by weight of the total composition, excluding any additives.

Suitable lubricants include for example, fatty acid esters such as alkyl stearyl esters, e.g., methyl stearate or the like; mixtures of methyl stearate and hydrophilic and hydrophobic surfactants including polyethylene glycol polymers, polypropylene glycol polymers, and copolymers thereof e.g., methyl stearate and polyethylene-polypropylene glycol copolymers in a suitable solvent; or combinations including at least one of the foregoing lubricants. Lubricants are generally used in amounts of from 0.1 to 5 parts by weight, based on 100 parts by weight of the total composition, excluding any additives.

Suitable pigments include for example, organic pigments and inorganic pigments such as metal oxides and mixed metal oxides such as zinc oxide, titanium dioxides, iron oxides, rutiles, spinels, carbon black or the like; sulfides such as zinc sulfides, or the like; aluminates; sodium sulfo-silicates; sulfates and chromates; carbon blacks; zinc ferrites; ultramarine blue; Pigment Brown 24; Pigment Red 101; Pigment Yellow 119; pigment black 7; organic pigments such as azos, di-azos, quinacridones, perylenes, naphthalene tetracarboxylic acid compounds, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations including at least one of the foregoing pigments. Pigments are generally used in amounts of from 0.0001 to 10 parts by weight, based on 100 parts by weight based on 100 parts by weight of the total composition, excluding any additives, although it is to be understood that higher percentages may be used if the materials of the present invention are utilized to form masterbatches.

Suitable dyes include, for example, coumarin 460 (blue), coumarin 6 (green), nile red or the like; lanthanide complexes; hydrocarbon and substituted hydrocarbon dyes; polycyclic aromatic hydrocarbons; scintillation dyes (preferably oxazoles and oxadiazoles); aryl- or heteroaryl-substituted poly (2-8 olefins); carbocyanine dyes; phthalocyanine dyes and pigments; oxazine dyes; carbostyryl dyes; porphyrin dyes; acridine dyes; anthraquinone dyes; arylmethane dyes; azo dyes; diazonium dyes; nitro dyes; quinone imine dyes; tetrazolium dyes; thiazole dyes; perylene dyes, perinone dyes; bis-benzoxazolylthiophene (BBOT); and xanthene dyes; fluorophores such as anti-stokes shift dyes which absorb in the near infrared wavelength and emit in the visible wavelength, or the like; luminescent dyes such as 5-amino-9-diethyliminobenzo(a)phenoxazonium perchlorate; 7-amino-4-methylcarbostyryl; 7-amino-4-methylcoumarin; 3-(2′-benzimidazolyl)-7-N,N-diethylaminocoumarin; 3-(2′-benzothiazolyl)-7-diethylaminocoumarin; 2-(4-biphenylyl)-5-(4-t-butylphenyl)-1,3,4-oxadiazole; 2-(4-biphenyl)-6-phenylbenzoxazole-1,3; 2,5-Bis-(4-biphenylyl)-1,3,4-oxadiazole; 2,5-bis-(4-biphenylyl)-oxazole; 4,4′-bis-(2-butyloctyloxy)-p-quaterphenyl; p-bis(o-methylstyryl)-benzene; 5,9-iaminobenzo(a)phenoxazonium perchlorate; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-diethylamino-4-methylcoumarin; 7-diethylamino-4-trifluoromethylcoumarin; 2,2′-dimethyl-p-quaterphenyl; 2,2-dimethyl-p-terphenyl; 7-ethylamino-6-methyl-4-trifluoromethylcoumarin; 7-ethylamino-4-trifluoromethylcoumarin; nile red; rhodamine 700; oxazine 750; rhodamine 800; IR 125; IR 144; IR 140; IR 132; IR 26; IR5; diphenylhexatriene; diphenylbutadiene; tetraphenylbutadiene; naphthalene; anthracene; 9,10-diphenylanthracene; pyrene; chrysene; rubrene; coronene; phenanthrene or the like, or combinations including at least one of the foregoing dyes. Dyes are generally used in amounts of from 0.00001 to 5 parts by weight, based on 100 parts by weight of the total composition, excluding any additives, although it is to be understood that higher percentages may be used if the materials of the present invention are utilized to form masterbatches.

Suitable colorants include, for example titanium dioxide, anthraquinones, perylenes, perinones, indanthrones, quinacridones, xanthenes, oxazines, oxazolines, thioxanthenes, indigoids, thioindigoids, naphthalimides, cyanines, xanthenes, methines, lactones, coumarins, bis-benzoxazolylthiophene (BBOT), napthalenetetracarboxylic derivatives, monoazo and disazo pigments, triarylmethanes, aminoketones, bis(styryl)biphenyl derivatives, and the like, as well as combinations including at least one of the foregoing colorants. Colorants are generally used in amounts of from 0.1 to 5 parts by weight, based on 100 parts by weight of the total composition, excluding any additives, although it is to be understood that higher percentages may be used if the materials of the present invention are utilized to form masterbatches.

Additionally, materials to improve flow and other properties may be added to the composition, such as low molecular weight hydrocarbon resins. Particularly useful classes of low molecular weight hydrocarbon resins are those derived from petroleum C₅ to C₉ feedstock that are derived from unsaturated C₅ to C₉ monomers obtained from petroleum cracking. Non-limiting examples include olefins, e.g. pentenes, hexenes, heptenes and the like; diolefins, e.g. pentadienes, hexadienes and the like; cyclic olefins and diolefins, e.g. cyclopentene, cyclopentadiene, cyclohexene, cyclohexadiene, methyl cyclopentadiene and the like; cyclic diolefin dienes, e.g., dicyclopentadiene, methylcyclopentadiene dimer and the like; and aromatic hydrocarbons, e.g. vinyltoluenes, indenes, methylindenes and the like. The resins can additionally be partially or fully hydrogenated.

The one or more additives are added to the long glass fiber-filled thermoplastic materials in a manner that improves their dispersion during processing of the long glass fiber-filled thermoplastic materials to form a molded article. As they are more easily dispersed, less processing and/or shear is required to disperse them, thereby substantially maintaining the integrity of the long fibers resulting in a molded article that has improved characteristics associated with the additive and that has improved physical properties due to less breakage of the long glass fibers. In one embodiment, the one or more additives includes a color additive, such as a pigment, dye, colorant or combination thereof, such that the resulting molded article has improved color evenness due to better dispersion of the color additive. In another embodiment, the one or more additives includes a flame retardant such that the resulting molded article has improved flame retardancy due to better dispersion of the flame retardant additive. In still another embodiment, the one or more additives includes a weatherability additive, such as a light stabilizer or a UV stabilizer, such that the resulting molded article has improved weatherability due to better dispersion of the weatherability additive.

As discussed, in one embodiment, the present invention helps solve the problems of prior art two pellet solutions, such as for forming molded articles having a selected color. One of the common approaches to a custom color matched long glass thermoplastic product is a two pellet dry blend consisting of a natural long glass fiber thermoplastic pellet and second color master-batch pellet. Offering a custom color long fiber filled thermoplastic in a single pellet form has been a challenge due to the degradation of the pigments and color additives during the pultrusion process which is typically used in the manufacture of the long fiber products. This present invention describes an approach to achieve excellent color uniformity in a single pellet form of a long fiber thermoplastic. Accordingly, to achieve improved dispersion of any additives in the long glass fiber-filled thermoplastic materials, the present invention also provides a method of forming the long glass fiber-filled thermoplastic materials wherein the additive is added as part of a separate coating applied after the thermoplastic resin has been reinforced with the long glass fiber but prior to the formation of a molded article. In this embodiment, the method of forming the long glass fiber-filled thermoplastic materials includes a first step wherein the thermoplastic resin is extruded and impregnated with long glass fiber. After the thermoplastic resin has cooled slightly to temperatures above it's glass transition, but prior to molding, a separate coating layer is applied to the long glass fiber-filled thermoplastic resin to form the long glass fiber-filled thermoplastic materials.

In addition to avoiding degradation of any colorant, the concepts of the present invention also help prevent degradation of any other additives utilized, such as a flame retardant or a weatherability additive. As such, a molded article made using the concepts of the present invention also provide long-fiber reinforced materials having enhanced flame retardant and/or weatherability characteristics due, in part, to better distribution of the additive and/or less degradation of the additive, thereby making the single pellet embodiments disclosed therein an improvement on two pellet prior art solutions for adding an additive to a polymeric material.

The following examples serve to illustrate the invention but are not intended to limit the scope of the invention.

### EXAMPLES

In the first set of Examples, the materials produced used weatherability additives. The materials produced in these examples were based on acrylonitrile-styrene-acrylonitrile block copolymer (ASA). A long glass fiber lace was pultruded through a ASA resin bath designed to impregnate the long glass fiber resulting in approximately 55% glass fiber content. After exiting the pultrusion process with a controlled glass level, the resin/glass lace was then pulled into specially designed process chamber where a second layer of resin composition comprised of impact modifiers, weatherability additives, heat stabilizers and/or color pigments was applied around the outside of the lace at a controlled rate. This second layer contained a concentrated level of a weatherability additive to provide weatherability to the molded article formed from the compositions when the final pellets are melted and mixed in an injection molding process. The over coat layer bonded to the base lace since the base layer was not fully cooled when the second layer was applied. The over coated layers were then fully cooled and then pelletized to a length of approximately 13 mm. These pellets were then injection molded into the final parts, in this case test bars.

Table 1 lists the formulations for three embodiments of the present invention using a weatherability additive with test results set forth in Table 2 for these embodiments.

TABLE 1

| | 20% ASA | 30% ASA | 40% ASA |
|---|---|---|---|
| Description | LFRT | LFRT | LFRT |
| Raw Materials | 070135-1 | 070135-2 | 070135-3 |
| PPG 4588 Roving | 20 | 30 | 40 |
| Bulk MMA SAN | 66.18 | 62.02 | 53.19 |
| ASA HRG | 12.02 | 6.19 | 5.05 |
| Irganox B225 | 0.42 | 0.38 | 0.36 |
| Glycolube C | 0.07 | 0.10 | 0.10 |
| CIBA Tinuvin 770 | 0.76 | 0.80 | 0.79 |
| CYASORB UV 5411 | 0.38 | 0.40 | 0.41 |
| Chemtura Naugard 412S | 0.18 | 0.11 | 0.11 |

Table 2 provides the mechanical property results for samples made in these examples. As can be seen, these results show that the compositions of the present invention can maintain an excellent balance of modulus versus impact performance in weatherable formulations. Further these compositions also exhibit very good dimensional stability as indicated by the low coefficient of linear thermal expansion (CLTE) values

TABLE 2

| | | | 20% ASA | 30% ASA | 40% ASA |
|---|---|---|---|---|---|
| | | | LFRT | LFRT | LFRT |
| Property | Test Method | Units | 070135-1 | 070135-2 | 070135-3 |
| Density | ASTM D 792 | | 1.27 | 1.349 | 1.4395 |
| ASH | ASTM D 5630 | % | 21.5 | 28.6 | 41.7 |
| CLTE | ASTM E 831 | | | | |
| Flow Direction | | um/(m-° C.) | 28.8 | 35.1 | n.a. |
| X-Flow Direction | | um/(m-° C.) | 50.1 | 67.9 | n.a. |
| Flexural Modulus | ISO 178 | MPa | 7795 | 9629 | 12125 |
| Flexural Strength | ISO 178 | MPa | 181 | 172 | 213 |
| Tensile Modulus | Iso 527 | MPa | 8264 | 9900 | 13694 |
| Tensile Stress @ Yield | Iso 527 | MPa | 129 | 116 | 150 |
| Tensile Stress @ Break | Iso 527 | MPa | 129 | 116 | 150 |
| Tensile Strain @ Yield | Iso 527 | % | 1.83 | 1.27 | 1.28 |
| Tensile Strain @ Break | Iso 527 | % | 1.8 | 1.28 | 1.28 |
| HDT 1.8 MPa | ISO 75 | C. | 93 | 93 | 96 |
| Notched Izod @ 23 C. | ISO 180 | kJ/m2 | 18 | 21 | 21 |
| Notched Izod @ −40 C. | ISO 180 | kJ/m2 | 19 | 23 | 22 |
| MA Impact @ 23 C. | ASTM D3763 | | | | |
| Energy to Max Load | | J | 5.4 | 5.7 | n.a. |
| Total Energy | | J | 11.3 | 14.1 | n.a. |
| MA Impact @ −40 C. | ASTM D3763 | | | | |
| Energy to Max Load | | J | 5.8 | 5.9 | n.a. |
| Total Energy | | J | 11.9 | 14.5 | n.a. |

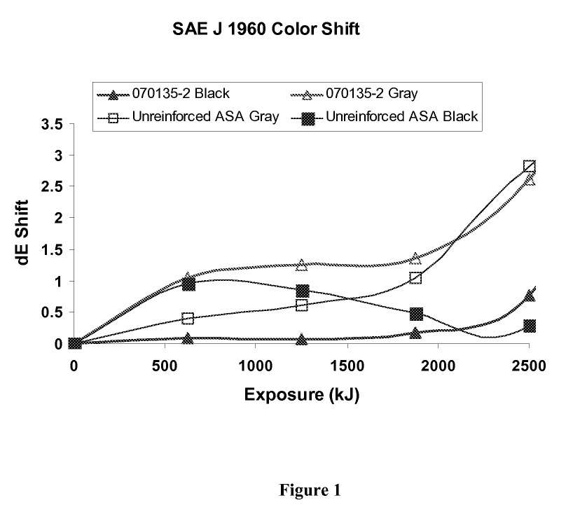

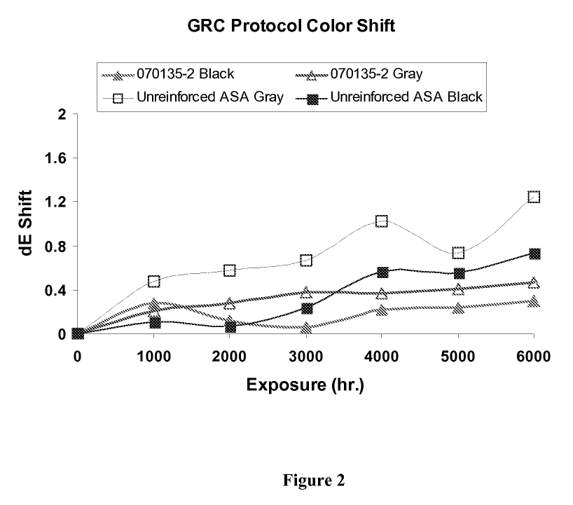

FIGS. 1 & 2 show the Accelerated Xenon Arc weathering results for one of these compositions (070135-2) in a black and gray color compared against existing un-reinforced ASA formulations in the same colors. Two different testing protocols were employed, the SAE J 1960 Xenon Arc Test & the GRC Protocol which is a modified version of the SAE J 1960 developed by the corporate research division of General Electric Co. In both the cases, the composition embodied in this invention showed an excellent retention of initial color as indicated by the low shift in the average (dE) of the L, a, b Gardner color vectors.

In the next set of Examples, compositions included a flame retardant as the additive to be dispersed. Table 3 provides the compositions of the three formulations used while Table 4 provides the mechanical property test results.

TABLE 3

| | 20% PC/ABS | 30% PC/ABS | 40% PC/ABS |
|---|---|---|---|
| Description | FR LFRT | FR LFRT | FR LFRT |
| Raw Materials | 070113-6 | 070113-8 | 070113-10 |
| PPG 4588 3.35 | 20 | 30 | 40 |
| HF1110-111 NAT | 60.6 | 50.7 | 41.7 |
| Bulk ABS | 4.0 | 4.0 | 4.0 |
| GE TSAN (F449) | 0.6 | 0.6 | 0.6 |
| B225 | 0.2 | 0.2 | 0.2 |
| Irgafos 168 | 0.2 | 0.2 | 0.2 |
| Chemtura 412S | 0.2 | 0.2 | 0.2 |
| PETS (Glycolube) | 0.2 | 0.2 | 0.2 |
| BPADP | 14.0 | 14.0 | 13.0 |

TABLE 4

| | | | 20% PC/ABS | 30% PC/ABS | 40% PC/ABS |
|---|---|---|---|---|---|
| | | | FR LFRT | FR LFRT | FR LFRT |
| Property | Test Method | Units | 070113-6 | 070113-8 | 070113-10 |
| Density | ASTM D 792 | | 1.36 | 1.441 | 1.51 |
| ASH | ASTM D 5630 | % | 22 | 30 | 40 |
| Flexural Modulus | ISO 178 | MPa | 7866 | 10092 | 12665 |
| Flexural Strength | ISO 178 | MPa | 153 | 163 | 175 |
| HDT 1.8 MPa | ISO 75 | C. | 85.6 | 87 | 88 |
| Notched Izod at 23 C. | ISO 180 | kJ/m2 | 16 | 25 | 30 |
| Tensile Modulus | Iso 527 | MPa | 8188 | 9000 | 10473 |
| Tensile Stress @ Yield | Iso 527 | MPa | 104 | 113 | 120 |
| Tensile Stress @ Break | Iso 527 | MPa | 104 | 113 | 120 |
| Tensile Strain @ Yield | Iso 527 | % | 1.4 | 1.4 | 1.1 |
| Tensile Strain @ Break | Iso 527 | % | 1.4 | 1.4 | 1.1 |
| Ul 94 | | | V0 @ 1.5 mm | V0 @ 1.5 mm | V0 @ 1.5 mm |
| Ul 95 | | | V1 @ 1.0 mm | V1 @ 1.0 mm | V1 @ 1.0 mm |

As may be seen in these examples, all three samples were able to achieve a V0 rating under UL-94 for samples having a thickness of 1.5 mm and a V1 rating under UL-94 for samples having a thickness of 1.0 mm while maintaining excellent physical properties.

In the third set of Examples, the materials produced used color pigments. The materials produced in these examples were based on blends (PC/ABS) of polycarbonate (PC) with the acrylonitrile-butadiene-styrene (ABS) terpolymer. A long glass fiber lace was pultruded through a PC resin bath designed to impregnate the long glass fiber resulting in approximately 55% glass fiber content. After exiting the pultrusion process with a controlled glass level, the resin/glass lace was then pulled into specially designed process chamber where a second layer of resin composition comprised of the ABS terpolymer, color pigments & heat stabilizers were applied around the outside of the lace at a controlled rate. This second layer contained a concentrated level of a color pigment & heat stabilizer additives to provide excellent color properties to the molded article formed from the compositions when the final pellets are melted and mixed in an injection molding process. The over coat layer bonded to the base lace since the base layer was not fully cooled when the second layer was applied. The over coated layers were then fully cooled and then pelletized to a length of approximately 13 mm. These pellets were then injection molded into the final parts, in this case test bars. For comparative purposes, these compositions were then compared to a conventional 2 pellet dry blend system consisting of the natural colored long glass fiber reinforced PC/ABS & a color pigment master-batch, mixed directly at the molding machine.

Table 5 shows examples of a 20% long glass reinforced PC/ABS single pellet color (SPC) compositions in a black, Orange, pigment blue and solvent blue color.

TABLE 5

| | Formula Sample Code | | | |
|---|---|---|---|---|
| | KK-N- | KK-N- | KK-N- | KK-N- |
| | 54497-7 | 54497-8 | 54497-9 | 54497-10 |
| | Description | | | |
| | Black SPC | Orange SPC | Blue pigment | Blue Solvent |
| Raw Materials | LFRT | LFRT | SPC LFRT | SPC LFRT |
| PPG 4588 3.35 Glass Roving | 20.00% | 20.00% | 20.00% | 20.00% |
| GE LEXAN HF1110-111 NAT | 65.50% | 65.50% | 65.50% | 65.50% |
| GE CYCOLAC 29449-1000 | 9.21% | 9.21% | 9.21% | 9.21% |
| LONZA GLYCOLUBE PETS | 0.12% | 0.12% | 0.12% | 0.12% |
| CIBA-GEIGY IRGANOX B225 | 0.40% | 0.40% | 0.40% | 0.40% |
| Cycoloy C1200HF | 3.23% | 4.11% | 4.56% | 4.51% |
| Zinc Sulfide | 1.48% | 0.50% | | |
| BLACK - Channel Powder | 0.05% | | | |
| Pigment Orange 75 (Global Master) | | 0.15% | | |
| Copper Phthalocyanine Pigment Blue 15:4 | | | 0.20% | |
| Solvent Blue 104 | | | | 0.25% |

Table 6 shows a comparison of mechanical properties between the 20% long glass reinforced PC/ABS single pellet color (SPC) compositions and the conventional 2-pellet LFRT dry blends.

TABLE 6

| | | | KK-N- | KK-N- | KK-N- | KK-N- | KK-N- | KK-N- | KK-N- | KK-N- |
|---|---|---|---|---|---|---|---|---|---|---|
| | | | 54497-7 | 54497-8 | 54497-9 | 54497-10 | 54497-17 | 54497-18 | 54497-19 | 54497-20 |
| | | | Black | Orange | Blue Pigment | Blue Solvent | Black Dry | Orange Dry | Blue pig Dry | Blue sol |
| | Test | | SPC | SPC | SPC | SPC | blend | blend | blend | Dry blend |
| Property | Method | Units | LFRT | LFRT | LFRT | LFRT | LFRT | LFRT | LFRT | LFRT |
| Flexural | ISO 178 | MPa | 6755 | 6939 | 6652 | 6963 | 6462 | 6395 | 6133 | 6269 |
| Modulus | | | | | | | | | | |
| Flexural | ISO 178 | MPa | 180 | 165 | 197 | 194 | 140 | 167 | 155 | 180 |
| Strength | | | | | | | | | | |
| Tensile | Iso 527 | MPa | 7401 | 7516 | 7107 | 7735 | 6922 | 6987 | 6897 | 6931 |
| Modulus | | | | | | | | | | |
| Tensile Stress | Iso 527 | MPa | 128 | 126 | 137 | 136 | 121 | 117 | 127 | 133 |
| @ Yield | | | | | | | | | | |
| Tensile Stress | Iso 527 | MPa | 128 | 126 | 137 | 136 | 121 | 117 | 127 | 133 |
| @ Break | | | | | | | | | | |

In another set of examples, exemplary classes of colorants were used to investigate color consistency in the Verton Xtreme Color, or single pellet color (SPC), process when compared to the dry blend (DB) process. The resin systems used in the study were PC/ABS and Nylon 6. The two glass loadings used with each resin were 20% and 40%. While all compositions were colored by both the VXC and DB methods using pigmentation systems highlighted in Table 7, commercial color mixtures were used with PA6 resin.

TABLE 7

| Color Package | Loading | Type |
|---|---|---|
| Pigment Blue 15:4 | 0.2% | Organic Pigment |
| Solvent Blue 104 at | 0.25% | Organic Dye |
| Pigment White 7/Pigment Orange 75 | 0.5%/0.15% | Inorganic |
| Pigment White 7/Pigment Black 7 | 1.5%/0.05% | Mixture |
| LNP Color Number BL5-834-1 | Proprietary | Commercial PA6 |
| for PA6 resin only | | Color (Mixture) |
| LNP Color Number YL3-151-1 | Proprietary | Commercial PA6 |
| for PA6 resin only | | Color (Mixture) |
| Natural = no pigments added | None | None |

Color measurements were collected from molded plastic articles of a flat matte surface finish using the ASTM E1164 (8.1.4) “Standard practice for obtaining spectrophotometric data for object-color evaluation,” ASTM E308 “Standard practice for computing the colors of objects by using the CIE system,” and ASTM D 2244 “Standard test method for calculation of color differences from instrumentally measured color coordinates.” Conditions of the measurements were CIE 1976 LAB, d/8° illumination/viewing geometry, 10° observer, illuminant D₆₅, specular component excluded (SCE) and UV filter adjusted to UV D₆₅.

The Standard deviations of absolute L*a*b* color values were used as dL*, da* and db* values respectively to measure color consistency within each batch of the colored chips. 10 molded chips were used to generate L*a*b* standard deviation data, each chip was measured at least 3 times. Total color difference (dE*) was calculated from the dL*, da* and db* values calculated as explained above.

Total Color Evenness Improvement was expressed in terms of % dE* as follows:

$$\% {dE}_{Total Color Evenness Improvement} = 100 \times \{ {dE}_{DB} - {dE}_{SPC} \} / {dE}_{DB}$$

The data obtained on all the samples is summarized in Table 8:

TABLE 8

| Grade | | | STDEV | | | | | | % Total Color Evenness |
|---|---|---|---|---|---|---|---|---|---|
| Composition | Process | Color | L | STDEV a | STDEV b | STDEV C | STDEV h | dE | Improvement (dE*) |
| 20% GF PA6 | SPC | 1.5% ZnS + 0.05 Carbon Black | 0.052 | 0.005 | 0.023 | 0.023 | 0.133 | 0.057 | 43.94 |
| 20% GF PA6 | DB | 1.5% ZnS + 0.05 Carbon Black | 0.093 | 0.010 | 0.038 | 0.038 | 0.256 | 0.101 | |
| 20% GF PA6 | SPC | 0.2% PIG-BL-15:4 | 0.274 | 0.183 | 0.425 | 0.414 | 0.517 | 0.537 | 16.03 |
| 20% GF PA6 | DB | 0.2% PIG-BL-15:4 | 0.295 | 0.370 | 0.431 | 0.433 | 0.854 | 0.640 | |
| 20% GF PA6 | SPC | 0.25% SOL-BL-104 | 0.312 | 0.170 | 0.605 | 0.570 | 1.064 | 0.701 | 64.39 |
| 20% GF PA6 | DB | 0.25% SOL-BL-104 | 0.474 | 0.715 | 1.773 | 1.848 | 1.639 | 1.969 | |
| 20% GF PA6 | SPC | Natural | 0.709 | 0.171 | 0.456 | 0.366 | 5.632 | 0.860 | 13.46 |
| 20% GF PA6 | DB | Natural | 0.887 | 0.146 | 0.424 | 0.343 | 4.244 | 0.994 | |
| 20% GF PA6 | SPC | 0.5% ZnS + 0.15% PIG-OR-75 | 0.129 | 0.227 | 0.125 | 0.254 | 0.085 | 0.289 | 50.45 |
| 20% GF PA6 | DB | 0.5% ZnS + 0.15% PIG-OR-75 | 0.182 | 0.485 | 0.268 | 0.554 | 0.043 | 0.583 | |
| 20% GF PCA | SPC | 1.5% ZnS + 0.05 Carbon Black | 0.070 | 0.017 | 0.077 | 0.077 | 0.436 | 0.105 | 73.39 |
| 20% GF PCA | DB | 1.5% ZnS + 0.05 Carbon Black | 0.390 | 0.019 | 0.062 | 0.062 | 0.608 | 0.395 | |
| 20% GF PCA | SPC | 0.2% PIG-BL-15:4 | 0.149 | 0.124 | 0.392 | 0.379 | 0.449 | 0.438 | 43.31 |
| 20% GF PCA | DB | 0.2% PIG-BL-15:4 | 0.260 | 0.629 | 0.364 | 0.372 | 1.820 | 0.772 | |
| 20% GF PCA | SPC | 0.25% SOL-BL-104 | 0.100 | 0.074 | 0.267 | 0.276 | 0.158 | 0.295 | 40.24 |
| 20% GF PCA | DB | 0.25% SOL-BL-104 | 0.176 | 0.114 | 0.447 | 0.459 | 0.295 | 0.493 | |
| 20% GF PCA | SPC | Natural | 0.542 | 0.045 | 0.173 | 0.122 | 2.357 | 0.570 | 22.90 |
| 20% GF PCA | DB | Natural | 0.684 | 0.078 | 0.271 | 0.102 | 5.050 | 0.740 | |
| 20% GF PCA | SPC | 0.5% ZnS + 0.15% PIG-OR-75 | 0.208 | 0.313 | 0.224 | 0.381 | 0.109 | 0.437 | 41.33 |
| 20% GF PCA | DB | 0.5% ZnS + 0.15% PIG-OR-75 | 0.210 | 0.639 | 0.323 | 0.714 | 0.090 | 0.746 | |
| 40% GF PA6 | SPC | 1.5% ZnS + 0.05 Carbon Black | 0.082 | 0.022 | 0.023 | 0.024 | 0.589 | 0.088 | 20.91 |
| 40% GF PA6 | DB | 1.5% ZnS + 0.05 Carbon Black | 0.108 | 0.014 | 0.025 | 0.025 | 0.387 | 0.112 | |
| 40% GF PA6 | SPC | 0.2% PIG-BL-15:4 | 0.097 | 0.100 | 0.255 | 0.250 | 0.277 | 0.290 | 51.56 |
| 40% GF PA6 | DB | 0.2% PIG-BL-15:4 | 0.288 | 0.417 | 0.320 | 0.304 | 1.094 | 0.600 | |
| 40% GF PA6 | SPC | 0.25% SOL-BL-104 | 0.313 | 0.247 | 0.437 | 0.480 | 0.800 | 0.591 | 27.41 |
| 40% GF PA6 | DB | 0.25% SOL-BL-104 | 0.244 | 0.335 | 0.702 | 0.751 | 1.238 | 0.815 | |
| 40% GF PA6 | SPC | Natural | 0.986 | 0.117 | 0.228 | 0.227 | 1.093 | 1.019 | 3.00 |
| 40% GF PA6 | DB | Natural | 0.997 | 0.093 | 0.319 | 0.185 | 5.134 | 1.051 | |
| 40% GF PA6 | SPC | 0.5% ZnS + 0.15% PIG-OR-75 | 0.204 | 0.277 | 0.156 | 0.317 | 0.056 | 0.378 | 39.59 |
| 40% GF PA6 | DB | 0.5% ZnS + 0.15% PIG-OR-75 | 0.188 | 0.529 | 0.277 | 0.595 | 0.099 | 0.626 | |
| 40% GF PCA | SPC | 1.5% ZnS + 0.05 Carbon Black | 0.138 | 0.009 | 0.045 | 0.045 | 0.260 | 0.145 | 2.09 |
| 40% GF PCA | DB | 1.5% ZnS + 0.05 Carbon Black | 0.142 | 0.023 | 0.034 | 0.033 | 0.705 | 0.148 | |
| 40% GF PCA | SPC | 0.2% PIG-BL-15:4 | 0.373 | 0.212 | 0.423 | 0.427 | 0.535 | 0.603 | 9.17 |
| 40% GF PCA | DB | 0.2% PIG-BL-15:4 | 0.310 | 0.409 | 0.421 | 0.425 | 1.062 | 0.663 | |
| 40% GF PCA | SPC | 0.25% SOL-BL-104 | 0.186 | 0.155 | 0.495 | 0.516 | 0.232 | 0.551 | 72.72 |
| 40% GF PCA | DB | 0.25% SOL-BL-104 | 0.723 | 0.132 | 1.883 | 1.846 | 1.090 | 2.021 | |
| 40% GF PCA | SPC | Natural | 0.945 | 0.123 | 0.296 | 0.285 | 1.130 | 0.998 | 47.82 |
| 40% GF PCA | DB | Natural | 1.829 | 0.106 | 0.547 | 0.488 | 2.728 | 1.912 | |
| 40% GF PCA | SPC | 0.5% ZnS + 0.15% PIG-OR-75 | 0.289 | 0.532 | 0.390 | 0.654 | 0.185 | 0.720 | 43.09 |
| 40% GF PCA | DB | 0.5% ZnS + 0.15% PIG-OR-75 | 0.316 | 1.165 | 0.381 | 1.171 | 0.766 | 1.265 | |
| 30% GF PCA | SPC | BL5-834-1 | 0.027 | 0.022 | 0.098 | 0.084 | 0.496 | 0.037 | 18.18 |
| 31% GF PCA | DB | BL5-834-1 | 0.033 | 0.139 | 0.291 | 0.121 | 2.652 | 0.138 | |
| 32% GF PCA | SPC | YL3-151-1 | 0.049 | 0.061 | 0.094 | 0.090 | 0.058 | 0.062 | 89.96 |
| 33% GF PCA | DB | YL3-151-1 | 0.488 | 0.564 | 1.914 | 1.841 | 0.684 | 4.470 | |

By comparing the dE values for the standard deviations of L, a and b values for the Verton Xtreme Color and the dry blend methods in Table 8, It could be shown that all samples have shown improved color consistency with the Verton Xtreme Color method. Depending on the color package, the average improvement in color consistency observed across samples was 37.95% and up to 89.96%. Natural samples also had shown improved color consistency.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A material for making long fiber filled thermoplastics with improved additive evenness and physical properties comprising:
a first thermoplastic resin material containing a plurality of reinforcing fiber strands; and
a second thermoplastic resin material containing at least one additive coated on the first thermoplastic resin material.

2. The material of claim 1, wherein the first thermoplastic material is selected from polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or a combination comprising at least one of the foregoing thermoplastic resins.

3. The material of claim 1, wherein the second thermoplastic material is selected from polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or a combination comprising at least one of the foregoing thermoplastic resins.

4. The material of claim 1, wherein the first thermoplastic material and the second thermoplastic material comprise the same thermoplastic material.

5. The material of claim 1, wherein the second thermoplastic material and the second thermoplastic material comprise different thermoplastic materials.

6. The material of claim 1, wherein the first thermoplastic material, the second thermoplastic material, or both comprise a polyamide.

7. The material of claim 1, wherein the reinforcing fiber strands are selected from glass fibers, carbon fibers, aramid fibers, or a combination comprising at least one of the foregoing fibers.

8. The material of claim 7, wherein the reinforcing fiber strands comprise glass fibers.

9. The material of claim 1, wherein the reinforcing fiber strands have a length greater than 0.5 mm.

10. The material of claim 1, wherein the reinforcing fiber strands have a length greater than 10 mm.

11. The material of claim 1, wherein the additive is selected from a color additive, a flame retardant, a weatherability additive, or a combination including at least one of the foregoing additives.

12. A method of making long fiber filled thermoplastics with improved additive evenness and physical properties comprising the steps of:
pultruding a first thermoplastic resin material having a plurality of reinforcing fiber strands contained therein; and
extruding a second thermoplastic resin material containing at least one additive onto the first thermoplastic resin material to form a coating on at least a portion of the first thermoplastic resin material.

13. The method of claim 12, wherein the first thermoplastic material is selected from polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or a combination comprising at least one of the foregoing thermoplastic resins.

14. The method of claim 12, wherein the second thermoplastic material is selected from polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or a combination comprising at least one of the foregoing thermoplastic resins.

15. The method of claim 12, wherein the first thermoplastic material and the second thermoplastic material comprise the same thermoplastic material.

16. The method of claim 12, wherein the second thermoplastic material and the second thermoplastic material comprise different thermoplastic materials.

17. The method of claim 12, wherein the first thermoplastic material, the second thermoplastic material, or both comprise a polyamide.

18. The method of claim 12, wherein the reinforcing fiber strands are selected from glass fibers, carbon fibers, aramid fibers, or a combination comprising at least one of the foregoing fibers.

19. The method of claim 18, wherein the reinforcing fiber strands comprise glass fibers.

20. The method of claim 12, wherein the reinforcing fiber strands have a length greater than 0.5 mm.

21. The method of claim 12, wherein the reinforcing fiber strands have a length greater than 10 mm.

22. The method of claim 12, wherein the additive is selected from a color additive, a flame retardant, a weatherability additive, or a combination including at least one of the foregoing additives.
